(19) United States
(12) Patent Application Publication
(10) Pub. No.: US 2025/0288398 A1
(43) Pub. Date: Sep. 18, 2025

(54) Guided Scanning Systems and Methods

(71) Applicant: Cayster Inc., New York, NY (US)

(72) Inventor: Aditya Narayan, New York, NY (US)

(21) Appl. No.: 18/604,489

(22) Filed: Mar. 13, 2024

(51) Int. Cl. A61C 9/00; G06T 19/20

(52) U.S. Cl. CPC A61C 9/0053; G06T 19/20; G06T 2219/2004; G06T 2219/2016

(57) ABSTRACT

The present technology relates to devices, methods and systems for scanning the oral cavity, in particular for dental applications; and for providing 3-dimensional (3D) data that makes it easier for a dental professional to scan the oral cavity of a patient, without the need for extensive training in specialized equipment and software systems. A system or method herein can include a visual display, in which a generated 3D scan model is overlaid over a 3D template model, such that a user can look at it and be guided by it during the scanning process. Such devices, methods and systems can help a dental professional in any dental procedure, for example, to develop a dental treatment such as orthodontics, fitting a prosthesis such as a crown or bridge, or treating a cavity. The technology also relates to methods of scanning the oral cavity of a patient.

### BACKGROUND

The present technology relates to guided scanning systems and methods, in particular for dental applications.

In the field of dentistry, it is often desirable to take an impression of the topography within a patient's mouth in order to determine treatment for the patient. For example, the topography of tooth surfaces, the relative position of the maxillary (upper) and mandibular (lower) dental arches, the placement of the teeth within the mouth, the way the teeth touch during biting, and the like are all useful and at times necessary information for orthodontic, endodontic or other dental treatments. In such cases, highly accurate data can ensure success of treatment.

Dental impressions have traditionally been obtained through the use of physical equipment such as pastes and trays that are contacted with the patient's teeth to form an impression and then allowed to harden, thereby providing a mold for guidance in making items such as dentures, crowns and bridges. However, more recently, intra-oral digital scanning systems and computer-guided techniques have been developed, which have the goal of gathering the necessary topographical data and presenting it in a digital format, with minimal mess, discomfort and inconvenience.

Known intra-oral scanning devices are typically available as 3-dimensional (3D) handheld scanning devices that guide a user (a dental professional or technician) in scanning dental surfaces. Typically, the user has to make sure to navigate the 3D scanner in a certain manner, in order to obtain a meaningful scan. The resultant output is a 3D digital image of the interior of the patient's mouth, which the dental professional can then use to guide the manufacture of a dental appliance such as braces, retainer; crown, bridge, or other structure.

In known 3D scanning systems, a specific scan path is typically required. Such scan path is dependent on the specific algorithm utilized by the scanner manufacturer. A break in the contact with the predefined scan path, or moving too slowly or quickly, will diminish the accuracy of the scan. Therefore, the user must undergo extensive training to use the scanner properly to get optimal results, and must practice using the scanner in order to improve accuracy.

Because of its reliance on manual movement of the scanners, known scanners can suffer from inaccuracies, leading to inferior treatment results such as missed conditions, poorly-fitting dental appliances, or failure to alleviate alignment issues.

Therefore, an ongoing need exists for guided 3D scanning systems that are easy to learn with minimal training on specialized equipment and software systems, are easy to use, and that provide reliable and highly accurate results.

VOCABULARY

| Term | Meaning |
|---|---|
| 3D scan model | 3D model of the oral cavity scan of a patient |
| 3D template model | 3D model of a generic dental arch template |
| Tooth-cuboid | Cuboid encompassing a tooth in a 3D model |
| Wrapper-cuboid | Cuboid encompassing all the tooth-cuboids |
| | in a 3D model |
| Guided path | Guide-line on the 3D template model showing |
| | the doctor the path of scanning |

### SUMMARY

In certain embodiments, the present technology is directed to guided 3-dimensional (3D) scanning system comprising:
(a) a scanning device adapted to scan the oral cavity of a patient, the scanning device configured to capture a 3D scanned image of the oral cavity when placed within the oral cavity;
(b) a processor configured to: (i) capture and store the scanned image from the oral cavity captured by the scanning device; (ii) create a 3D scan model based upon the captured image; and (iii) align a 3D template model to the 3D scan model; and
(c) a visual display configured to show the 3D scan model overlaid on the 3D template model to produce a guided path, such that a user can view the guided path while scanning the oral cavity of the patient.

In certain embodiments, the present technology is directed to a method of guided scanning of the oral cavity of a patient, the method comprising the steps of:
(a) scanning one or more detected teeth of the patient to generate a 3-dimensional (3D) scan model, wherein the scanning step comprises detecting the identification, by tooth number, and orientation of each of the one or more detected teeth;
(b) generating one or more tooth-cuboids for a detected tooth with vertex order for a 3D template model and a 3D scan model, as shown in FIG. 10, to create a wrapper-cuboid of the one or more tooth-cuboids, wherein a tooth-cuboid has:
   (i) a length delineated by vertices v0-v1, v2-v3, v4-v5 and v6-v7;
   (ii) a heigh delineated by vertices v0-v3, v1-v2, v5-v6 and v4-v7; and
   (iii) a depth delineated by vertices v0-v4, v1-v5, v3-v7 and v2-v6; and
(c) applying an alignment algorithm to correctly align the 3D template model to the 3D scan model; wherein the alignment algorithm comprises the steps of:
   (i) rotating the wrapper-cuboid of the 3D template model so that the world axes become parallel to any three perpendicular faces of the wrapper-cuboid, and applying the same rotation to the 3D template model and updating the vertex coordinates of the 3D template model and the wrapper-cuboid with the rotated values;
   (ii) calculating the scale factor of the wrapper-cuboid of the 3D template model with respect to the wrapper-cuboid of the 3D scan model, where the scale factor for each axis is calculated using the following formula:

$$Scale Factor of ( x , y or z ) axis = \frac{length of edge ( {v}_{0} , {v}_{1} ) of wrapper - cuboid of 3 D scan model}{length of edge ( {v}_{0} , {v}_{1} ) of wrapper - cuboid of 3 D template model} ;$$

(iii) rotating the wrapper-cuboid of the 3D template model to align any two corresponding orthogonal planes of the two wrapper-cuboids, permitting third plane to automatically align; and
   (iv) translating the wrapper-cuboid of the 3D template model using 3D translation principles to match the position of the wrapper-cuboid of the 3D scan model, based on the difference between the positions of a particular vertex of the wrapper-cuboid of the 3D scan model and the wrapper-cuboid of the 3D template model.

In certain embodiments, the present technology is directed to a method of scanning the oral cavity of a patient, the method comprising following a guided path generated by a system herein.

In certain embodiments, the present technology is directed to methods of detecting, diagnosing or treating an oral condition, the method comprising diagnosing a treatment plan based on analysis of a guided path generated by a system herein; or of engaging in guided scanning of the oral cavity of a patient as described herein.

### BRIEF DESCRIPTION OF THE DRAWINGS

FIG. 1 shows a scanned image of a tooth in a patient's oral cavity as detected using a method or system herein.

FIG. 2 shows tooth-cuboids around each tooth on the 3D scan model. FIG. 2 also shows a full arch 3D template model and tooth-cuboids only around the tooth numbers which have been identified from the 3D scan model, in an embodiment herein.

FIG. 3 shows wrapper-cuboid around all the tooth-cuboids for both the 3D scan model and the 3D template model in an embodiment herein.

FIG. 4 shows vertex order for upper and lower tooth when creating tooth-cuboids for each tooth, in an embodiment herein.

FIG. 5 shows the lines and points with labels to create the wrapper-cuboid in an embodiment herein. This is explained in, for example, paragraph WRAPPER CUBOID THEORY

FIG. 6 shows a diagrammatic representation of the geometric calculations to get an outermost point of all the tooth-cuboids of the teeth having minimum distance from the line shown in red which is the same as the line from TS to TE shown in FIG. 5. Detailed explanation is given in, for example, paragraph [0039] WRAPPER_CUBOID_THEORY

FIG. 7 shows the template and its wrapper-cuboid, oriented such that the wrapper-cuboid edges are aligned with the axes, in an embodiment herein.

FIG. 8 shows the state after merging the 3D template model with the 3D scan model, in an embodiment herein.

FIG. 9 shows a real time guided path and pointer showing how to move the scanner in the patient's mouth when scanning to get a proper scan easily, in an embodiment herein.

FIG. 10 shows a tooth-cuboid for a detected tooth with vertex order for a 3D template model and a 3D scan model as discussed in the present disclosure.

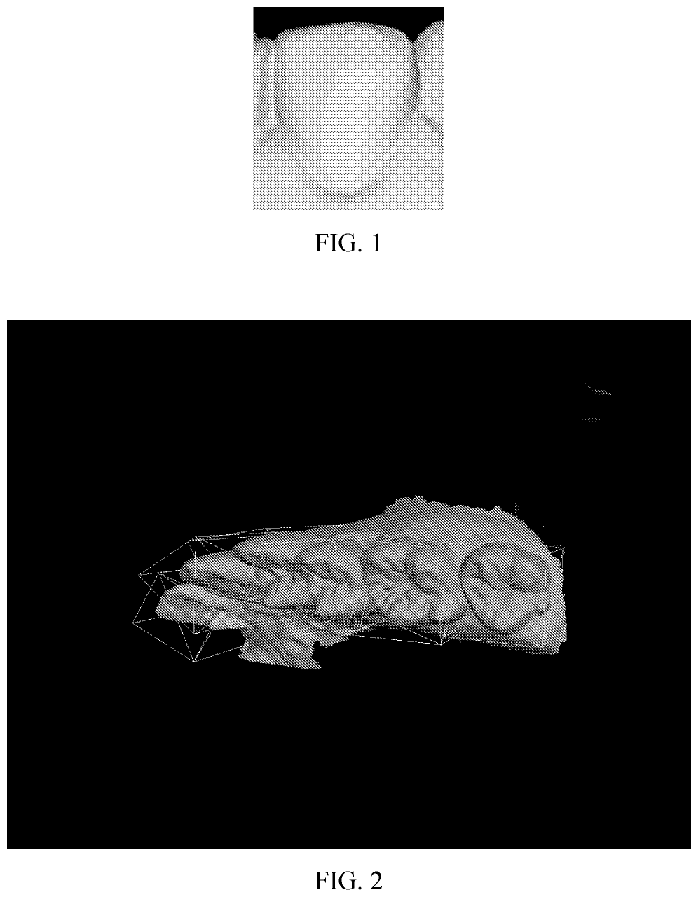

### DETAILED DESCRIPTION

As used herein, all singular terms refer to both singular and plural values. That is, “a” or “an” or “the” all mean “one or more.” The term “or” as used herein means any one or more of the alternatives, including all of the alternatives.

Throughout the present disclosure, when described in sequential words (for example, using “then” or “next”), such description is not limiting to the described steps in the particular order set forth, but also includes embodiments wherein the steps are presented in any order.

As used herein, “user” refers to anyone who uses the devices, methods or systems herein, such as a dental professional (e.g., anyone practicing dentistry, orthodontics, periodontics, prosthodontics, oral or maxillofacial surgery or pathology, anesthesiology, radiology, or dental public health), dental assistant, hygienist, technician, or robotic system. However, it is important to note that throughout the present disclosure, the use of the word “user” not limited to a particular person or persons, but can indicate actions performed by a machine, computer, a robot, or artificial intelligence (A.I.).

Various embodiments herein refer to a “scanning device.” As used herein, “scanning device” can refer to any unit that is capable of scanning an oral surface, whether handheld or not, automated, manual, or robotic, as will be discussed in greater detail herein. For example, a scanning device herein can be in the form of a handheld intraoral device operated by a dental professional. In other embodiments, a scanning device herein need not be operated by hand, but can be part of any device capable of being inserted, in whole or in part, into the oral cavity of a patient for scanning. For example, the present technology contemplates a device that can automatically scan a patient without the need for direct manual operation by a dental professional, e.g., completely robotic or remotely controlled, as this can improve hygiene.

In certain embodiments, a scanning device herein can be placed within the oral cavity—that is, any part of the device. In certain embodiments, a scanning device herein can capture multiple 3D scanned images—that is, 2 or more 3D scanned images of the oral cavity, and a processor herein is configured to create a 3D scanned model based upon the multiple captured images.

As used herein, “intra-oral” refers to the oral cavity of a patient's mouth. As used herein, “oral cavity” means the interior of a patient's mouth, including the oral mucosa, tongue, one or more teeth (whether natural or artificial), and any dental appliances located within the mouth. As used herein, “dental appliance” means any device used by a dental professional to treat a dental condition, including braces, fixed retainers, removable retainers, fillings, bridges, dental crowns, dentures, implants, mouth guards, and devices for treating sleep apnea including mandibular advancement devices. As used herein, “oral mucosa” means the mucous membrane lining or skin surface inside the mouth, including the cheeks and lips.

In certain embodiments, a system herein provides a guided scanning feature. As used herein, “guided scanning” means a scanning system that includes a guided path on a template-based 3D model presented on the computer screen. As used herein, “guided path” refers to the display (generally, in the form of a line) that shows the user how to move the scanning device along the oral cavity during the scan. The guided path can have the effect of guiding the user to follow a highly efficient path, producing a high quality scan in a short time with minimal training required. Herein, when referring to the guided path, the term “guided image” is also used to refer to the overall picture that includes the guided path on the visual display, that the dental professional can use when scanning the patient.

In certain embodiments, a system herein can be useful because it can be mastered by the user without the need for extensive training. That is, a system herein can have sufficiently straightforward ease of use, such that a user can merely operate the scanner and follow, on a visual display, the guided path that overlays on a 3D template model.

In certain embodiments, the present technology is directed to a method of treating an oral condition. As used herein, “oral condition” means a missing tooth, misaligned teeth or jaw (e.g., an orthodontic oral condition), caries or tooth decay (e.g., a dental or endodontic oral condition), gum disease (e.g., a periodontic oral condition) or any medical condition that adversely affects the oral mucosa, including but not limited to the teeth or gums.

In various embodiments, a system or method herein can be used to detect, diagnose, or treat any oral condition; for example, to develop or implement a treatment plan such as treatment of cavities, alignment of the jaw, the application of orthodontic appliance, a surgical procedure, or the like. As used herein, “detect” means to ascertain the existence or non-existence of a condition of the body; “diagnose” means to determine that some medical or dental condition exists or does not exist; and “treat” means to decrease, to any extent, the adverse effects of any condition, including to ameliorate or improve the condition, even if not completely.

As used herein, “contemporaneously” means in the same period of time, or as part of the same procedure (e.g., a dental procedure) but not necessarily exactly simultaneously.

### Phase 1—Alignment Backend Computation

In certain embodiments, a method or system herein comprises a first phase, which is generally directed to alignment computation, and in certain embodiments, is not discernable to the user.

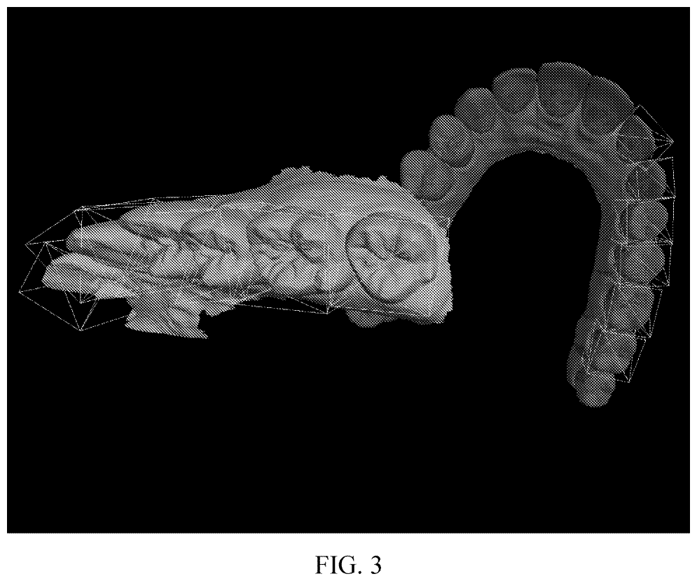

In the beginning of the scan, the relative positions, scanner and orientation of these two models are unknown—i.e., there exists no transform T that can be applied to the 3D template model to align it with the 3D scan model, or vice versa (for example, as shown in FIG. 2). In order to effectively place the guided path on the template. in certain embodiments the two models can be aligned for which we need to derive T. In certain embodiments, this can be accomplished by identifying six parameters for relative position and orientation. However, this is not enough. The curvature of the arch and the tooth sizes are also likely to be different from the template. In certain embodiments, this can be accomplished with a combination of practical algorithms for deriving T which can then be applied in order to overlay the guiding lines with precision. An embodiment of such a solution is outlined below.

Tooth Identification—In certain embodiments, as soon as the user begins to scan with the scanning device, a 3D representation (3D scan model) starts to form, and can be shown on the visual display. At this stage, the aim is to uniquely identify the teeth that have been scanned up to this point. One of the many versatile ways of doing this, and by detecting the presence of one or more teeth in the oral cavity in general, is by applying artificial intelligence (A.I.), for example, a Neural Network that has been pre-trained with a sufficiently large number of samples. Alternative approaches for identifying tooth numbers such as traditional rule-based algorithms can also be used.

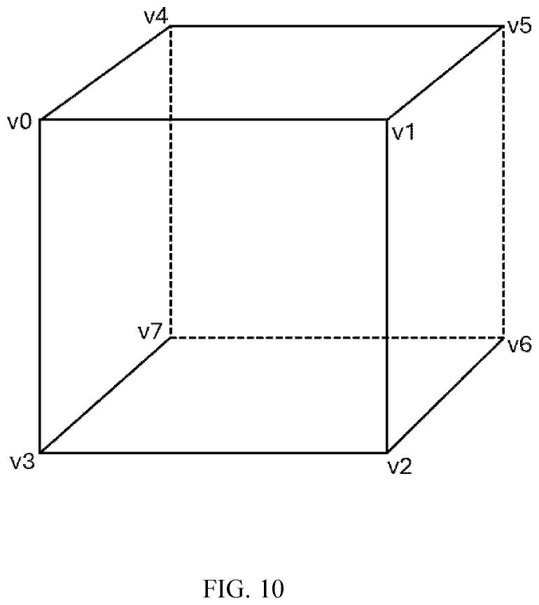

Once the teeth have been identified, the one or more tooth-cuboids can be formed around each detected tooth using geometric principles, for example, as shown in FIG. 10.

An exemplary illustration of the tooth-cuboids for identified teeth in such embodiments is shown in FIG. 2.

Loading template—In certain embodiments, based on tooth information, the upper or lower full arch template can be loaded. Tooth-cuboids for the same identified teeth can be selected in the 3D template model, which are predetermined as part of a design step. FIG. 2 shows an embodiment tooth-cuboids of the 3D scan model as well as the 3D scan template in certain embodiments.

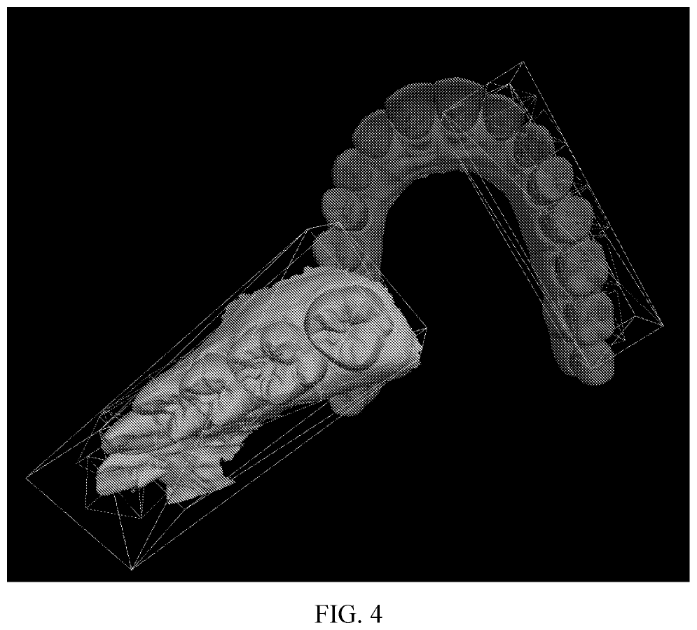

Wrapper-cuboid around all the tooth-cuboids—In certain embodiments, for each detected tooth on the 3D scan model, its coordinates and orientation can be combined using geometric principles to calculate the tooth-cuboid in 3D space. In certain embodiments, a wrapper-cuboid can now be created, which includes all the generated tooth-cuboids for detected teeth (one or more). Another similar wrapper-cuboid can be created with the same set of tooth-cuboids of the 3D template model, as shown, for example, in FIG. 3.

For example, let's say only tooth 9 has been identified. In certain embodiments, after applying a method or system herein, there will be a tooth-cuboid around tooth 9, and a wrapper-cuboid around the tooth-cuboid of tooth 9.

Next, let's say tooth 10 has also been detected along with tooth 9. In certain embodiments, applying a method or system herein will result in tooth-cuboids around both tooth 9 and tooth 10, and this time the wrapper-cuboid will encompass the tooth-cuboids of both tooth 9 and tooth 10.

Various approaches can be used to generate the wrapper-cuboid around a set of tooth-cuboids. One of these approaches is illustrated below.

In certain embodiments, when creating the tooth-cuboid around a tooth, the vertex positions can be kept in a certain sequence for both lower and upper teeth.

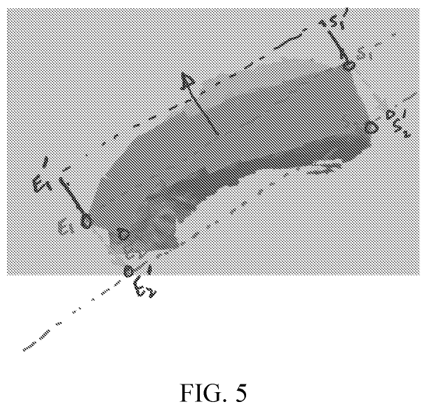

In another illustrative example, let's take the top edge vertex v₁ of the tooth-cuboid of the first detected tooth and call it TS, and the top edge vertex v₀ of the tooth-cuboid of the last detected tooth and call it TE, as shown in, e.g., FIG. 5.

Pseudocode illustrating the WRAPPER_CUBOID_THEORY

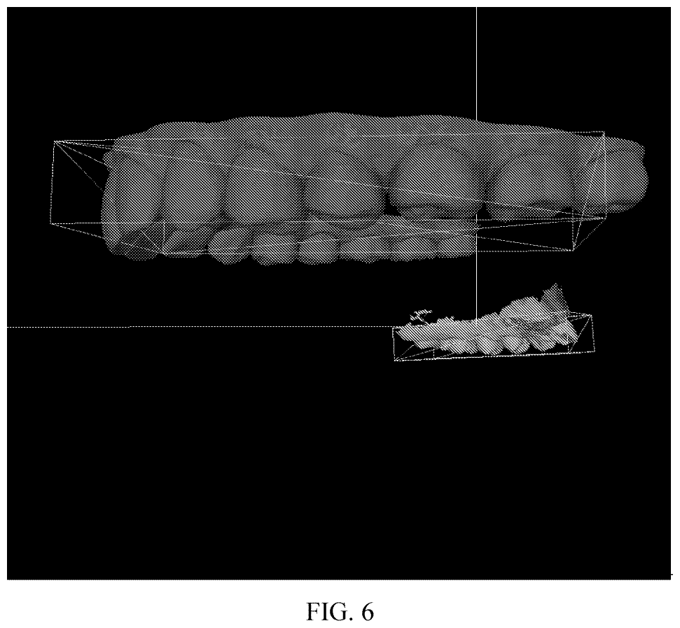

```
TS = Vertex v1 of the first detected tooth
TE = Vertex v0 of the last detected tooth
distance_direction_array = new blank array
tooth-cuboids = list of all the tooth-cuboids
for each tooth-cuboid in tooth-cuboids {
  Line L1 = line passing through TS and TE
  Line L2 = line passing through v1 and v2 of tooth-cuboid
  Vertex IL1 = Vertex at which the normal from v1 intersects
the line L1
  Vertex IL2 = Vertex at which the normal from IL1
intersects the line L2
  Vertex IL3 = Vertex at which the normal from IL2
intersects the line L1
  dist = Distance between vertices IL2 and IL3
  dir = Direction from IL3 to IL2
  dist_dir_pair = (dist, dir)
  distance_direction_array.push(dist_dir_pair)
dist_dir_pair_max = pair with maximum dist stored in
distance_direction_array
max_distance = dist of dist_dir_pair_max
point_direction = dir of dist_dir_pair_max
### Refer to Fig 6
Create a point TS1 which is at a distance max_distance from TS
in the direction point_direction
Create another point TS1 which is at a distance max_distance
from TE in the direction point_direction
### Since point_direction is perpendicular to line (TS, TE),
angle (TE1,TE,TS) and angle (TS1,TS,TE) will be 90o
### Similarly, by finding out the maximum distance between line
line (TS,TE) and all the lines (v5,v6) for each detected
cuboid, points TE2 and TS2 can be obtained.
### So, vertices TS1, TE1, TE2, TS2 will give the top
rectangular face of the overall cuboid.
### Similarly, vertices v2 and v6 can be used instead of v1 and
v2 to find the vertices BS1, BE1, BE2, BS2 of the bottom
rectangular face of the overall cuboid.
```

For this embodiment, the overall cuboid is shown in FIG. 5.

### [ALIGNMENT_ALGORITHM]:

The following assumes the use of standard 3D transformation matrices for rotation, scaling and translation. In an exemplary process or method herein, one or more of the following steps can be performed:

Step 1: Rotate the wrapper-cuboid of the 3D template model so that the world axes become parallel to any three perpendicular faces of the wrapper-cuboid. Apply the same rotation to the 3D template model and update the vertex coordinates of the 3D template model and the wrapper-cuboid with the rotated values. This is for efficiency so that we do not need to repeatedly perform the rotations.

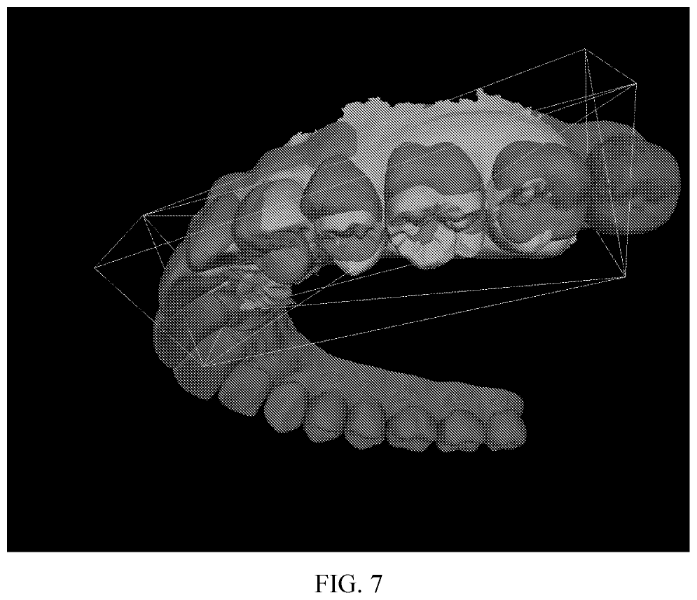

Referring to the exemplary embodiment shown in FIG. 7:
Step 2: Calculate the scale factor of the wrapper-cuboid of the 3D template model with respect to the wrapper-cuboid of the 3D scan model. Both, the 3D template model and its wrapper-cuboid, are scaled using the scale factor. This will make the 3D template model size similar to the 3D scan model size.

### Scale Factor Calculation

$$Let ' s say that the edge ( {v}_{0} , {v}_{1} ) of a wrapper - cuboid is aligned \\ to the x - axis , ( {v}_{4} , {v}_{5} ) is aligned to the y - axis and ( {v}_{12} , {v}_{13} ) \\ is aligned to the z - axis .$$

$$Scale Factor of x axis = \frac{length of edge ( {v}_{0} , {v}_{1} ) of wrapper - cuboid of 3 D scan model}{length of edge ( {v}_{0} , {v}_{1} ) of wrapper - cuboid of 3 D template model}$$

$$Similarly , we can find the scale factor in y and z axes .$$

Step 4: The wrapper-cuboid of the 3D template model can be rotated to align any two corresponding orthogonal planes of the two wrapper-cuboids. When this is done, the third plane will automatically align.
Step 5: Based on the difference between the positions of a particular vertex (say v₀) of the wrapper-cuboid of the 3D scan model and the wrapper-cuboid of the 3D template model, the wrapper-cuboid of the 3D template model can be translated using 3D translation principles to match the position of the wrapper-cuboid of the 3D scan model.

In certain embodiments, the above steps can be applied at different intervals, as the user keeps scanning more and more teeth. In certain embodiments, the transform T is only approximately known at any given time, but additional scanned data can make it more precise.

In general,
T=T_{(i,j)}, where i=the i^{th} identified starting tooth and j=the j^{th} identified ending tooth.
   For example, if only tooth 9 is initially scanned, then T=T_{(9,9)}

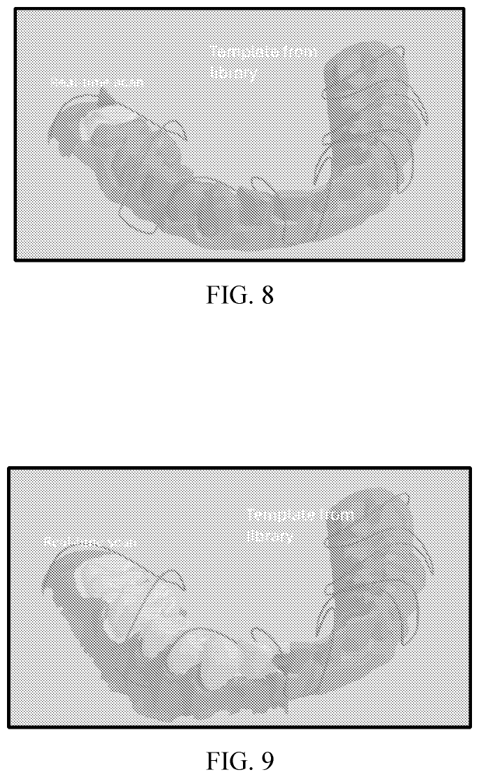

Next, let's say tooth 10 is also scanned after tooth 9, then T=T_{(9,10)}, and so on. Referring to FIG. 8, in certain embodiments, the algorithm ensures that the wrapper-cuboid of the 3D template model will perfectly (or substantially) merge with the wrapper-cuboid of the 3D scan model, and the 3D template model will automatically converge to the 3D scan model as more teeth are scanned. Since every patient's dental arches are unique, perfect alignment cannot be guaranteed, but in our tests we have observed that with 3 tooth-cuboids, the alignment is nearly perfect to the extent that a user observing this on a computer screen cannot visually discern any misalignment without great effort.

In our tests, for 3 cuboids the error between the predicted template and actual scan ranges between 2% to 8% based on suitably defined error metrics. A simplified approach was used where error e is defined as e²=ex²+ey²+ez²

where each term is the misalignment ratio (Δ/linear distance) along an individual dimension (x,y,z) for the cuboid center of the tooth that's furthest from the origin. Note that in certain embodiments, this slight discrepancy is never apparent to the user as the actual scan and template are never shown together for the same teeth. In other embodiments, the error between the predicted template and actual scan is less than 15%, less than 10%, less than 8%, less than 5%, or less than 3%. That is, in certain embodiments, using the methods and systems herein will result in a guided image that depicts a guided path, having an error (e) between the guided path and the actual scan is less than 10% based on the following equation:

$$e 2 = ex 2 + ey 2 + ez 2$$

where each term is the misalignment ratio (Δ/linear distance) along an individual dimension (x,y,z) for the tooth cuboid center of the tooth that is furthest from the origin.

Thus, the above steps can lead to a fairly good approximation of transform T—i.e., we have found a way to transform the 3D template model to match with the 3D scan model.

In certain embodiments, once the 3D template model is aligned with the 3D scan model, one or more guided paths can be overlaid on the template.

### Phase 2—Guided Scanning

Once the 3D template model is aligned with the real-time 3D scan model, in certain embodiments herein, the guided path can be overlaid on the 3D template model in a visual display in connection with a system or method herein. This portion of a system or method herein can, in certain embodiments, be visible to the user or patient. This guided path in 3D space is typically referred to as the scan path and is prescribed by the scanner manufacturers. These are usually illustrated to the user during training in a non real-time manner, either as printed guides or through video tutorials.

In certain embodiments, as the user follows the guided path, more of the real-time scan can be obtained. However, there is no guarantee that the initial alignment of the models will be valid. Therefore, in certain embodiments, the algorithm described in Phase 1 above can be continuously applied, and the two models can be kept synchronized using T, with additional information available in each iteration of the algorithm, for example, as shown in FIG. 9.

In certain embodiments, a system herein can include feedback to the user to indicate successful scanning, such as the input of adequate data from the scanner for the system to provide an optimal result; or any problem with the scanning, such as inadequate contact, or inadequate data provided from the patient, or a user's straying from the path guided by the user interface, or any error, as a way of indicating to the user that the scan needs to be repeated, or the methodology needs to be adjusted. These can include, for example, visual feedback such as a light (for example, different color, blinking, or the like); or aural feedback such as a chime (for example, one chime shows that the user is properly following the path, or another chime indicates that the user has strayed from the path); or tactile feedback such as haptic feedback.

Although the present technology has been described in relation to embodiments thereof, these embodiments and examples are merely exemplary and not intended to be limiting. Various modifications and alterations to the described embodiments will be apparent to those skilled in the art. The present technology should, therefore, not be limited by the specific disclosure herein, and can be embodied in other forms not explicitly described here, without departing from the spirit thereof.

1. A guided 3-dimensional (3D) scanning system comprising:
a) a scanning device adapted to scan the oral cavity of a patient, the scanning device configured to capture a 3D scanned image of the oral cavity when placed within the oral cavity;
(b) a processor configured to: (i) capture and store the scanned image from the oral cavity captured by the scanning device; (ii) create a 3D scan model based upon the captured image; and (iii) align a 3D template model to the 3D scan model; and
(c) a visual display configured to show the scanned image overlaid on the 3D template model to produce a guided path, such that a user can view the guided path while scanning the oral cavity of the patient.

2. The system of claim 1, wherein the scanning device captures multiple 3D scanned images of the oral cavity, and the processor is configured to create the 3D scanned model based upon the multiple captured images.

3. The system of claim 1, wherein the oral cavity comprises one or more teeth.

4. The system of claim 3, wherein the scanning device is a handheld intraoral scanning device.

5. The system of claim 3, wherein the one or more teeth are detected by application of artificial intelligence (A.I.).

6. The system of claim 5, wherein in A.I. is in the form of a neural network that has been pre-trained with a sufficiently large number of samples.

7. A method of guided scanning of the oral cavity of a patient, the method comprising the steps of:
(a) scanning one or more detected teeth of the patient to generate a 3-dimensional (3D) scan model, wherein the scanning step comprises detecting the identification, by tooth number, and orientation of each of the one or more detected teeth;
(b) generating one or more tooth-cuboids for a detected tooth with vertex order both for 3D template model and 3D scan model
to create a wrapper-cuboid of the one or more tooth-cuboids, wherein a tooth-cuboid has:
(i) a length delineated by vertices v0-v1, v2-v3, v4-v5 and v6-v7;
(ii) a heigh delineated by vertices v0-v3, v1-v2, v5-v6 and v4-v7; and
(iii) a depth delineated by vertices v0-v4, v1-v5, v3-v7 and v2-v6; and
(c) applying an alignment algorithm to correctly align the 3D template model to the 3D scan model; wherein the alignment algorithm comprises the steps of:
(i) rotating the wrapper-cuboid of the 3D template model so that the world axes become parallel to any three perpendicular faces of the wrapper-cuboid, and applying the same rotation to the 3D template model and updating the vertex coordinates of the 3D template model and the wrapper-cuboid with the rotated values;
(ii) calculating the scale factor of the wrapper-cuboid of the 3D template model with respect to the wrapper-cuboid of the 3D scan model, where the scale factor for each axis is calculated using the following formula:
$$Scale Factor of ( x , y or z ) axis = \frac{length of edge ( {v}_{0} , {v}_{1} ) of wrapper - cuboid of 3 D scan model}{length of edge ( {v}_{0} , {v}_{1} ) of wrapper - cuboid of 3 D template model} ;$$
(iii) rotating the wrapper-cuboid of the 3D template model to align any two corresponding orthogonal planes of the two wrapper-cuboids, permitting the third plane to automatically align; and
(iv) translating the wrapper-cuboid of the 3D template model using 3D translation principles to match the position of the wrapper-cuboid of the 3D scan model, based on the difference between the positions of a particular vertex of the wrapper-cuboid of the 3D scan model and the wrapper-cuboid of the 3D template model.

8. The method of claim 7, wherein the one or more teeth are detected by application of artificial intelligence (A.I.).

9. The system of claim 8, wherein in A.I. is in the form of a neural network that has been pre-trained with a sufficiently large number of samples.

10. A guided image generated by a method of claim 7.

11. The guided image of claim 10, wherein the error (e) between the guided path and the actual scan is less than 10% based on the following equation:
$$e 2 = ex 2 + ey 2 + ez 2$$
where each term is the misalignment ratio (Δ/linear distance) along an individual dimension (x,y,z) for the tooth cuboid center of the tooth that is furthest from the origin.

12. A method of treating an oral condition, the method comprising diagnosing a treatment plan based on analysis of a guided path generated by the system of claim 1.

13. A method of detecting, diagnosing or treating an oral condition, the method comprising the step of engaging in guided scanning of the oral cavity of a patient of claim 7.
